(19) United States
(12) Patent Application Publication
(10) Pub. No.: US 2026/0093730 A1
(43) Pub. Date: Apr. 2, 2026

(54) LANGUAGE MODEL TOOL CALLING AND EXECUTION PLATFORM

(71) Applicant: ARCADE AI, INC., SAN FRANCISCO, CA (US)

(72) Inventors: SAMUEL HOLT PARTEE, SAN FRANCISCO, CA (US); NATHANAEL ROBERT BARBETTINI, SAN MATEO, CA (US); STERLING PATRICK DREYER, OAKLAND, CA (US); ALEXANDER SALAZAR, BURLINGAME, CA (US)

(73) Assignee: ARCADE AI, INC., SAN FRANCISCO, CA (US)

(21) Appl. No.: 19/385,712

(22) Filed: Nov. 11, 2025

Related U.S. Application Data
(63) Continuation of application No. 19/356,111, filed on Oct. 11, 2025.
Application No. 19/356,111 is a continuation of application No. PCT/US25/48517, filed on Sep. 29, 2025.
(60) Provisional application No. 63/702,027, filed on Oct. 1, 2024.
(60) Provisional application No. 63/703,974, filed on Oct. 6, 2024.

(51) Int. Cl. G06F 9/448; G06F 16/3329

(52) U.S. Cl. CPC G06F 16/33295

(57) ABSTRACT

A system for processing client requests in an AI ecosystem is provided. The system may receive a client request from a client application, where the client request is based upon a user request. The system may provide a model request, based upon the client request, to a first model (e.g., an LLM), receive, from the first model, a structured response based upon the model request, and cause execution of tool functions based upon the structured response.

### CROSS-REFERENCE TO RELATED APPLICATIONS

The present application claims benefit of priority to U.S. Provisional App. Ser. No. 63/702,027, filed on Oct. 1, 2024, and U.S. Provisional App. Ser. No. 63/703,974, filed on Oct. 6, 2024, both of which are incorporated by reference herein for all purposes.

### FIELD

The disclosure relates generally to artificial intelligence (“AI”) models that are capable of inference with regards to the prediction of sequences of characters in a string, such as transformer (e.g., GPT) models, recurrent neural network models, or the like, and, in particular, to expanding the capabilities of AI models.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section represents different approaches, which in and of themselves may also correspond to implementations of the claimed technology.

Conventional artificial intelligence (“AI”) large language models, such as GPT-4, Claude 3, LlaMA 3.1, Gemini 1.5, etc., cannot send emails, order food, or book flights. They can write SQL code, but cannot query databases or work well with the results.

In general, limitations of current AI systems include:

Authentication and Authorization Roadblocks: AI currently lacks a secure method to access user data and services. Existing tools do not support end-user-based authentication or authorization, blocking key features or entire projects, such as AI assistants checking calendars or sending emails.

Integration Complexity: While traditional software has many integration tools, AI lacks this ecosystem. Connecting AI to external services (e.g., Gmail, Salesforce), internal custom services, and legacy systems is a complex maze of custom APIs, data formats, and authentication methods. This complexity slows development and limits AI's real-world impact.

Prohibitive Latency: Multiple slow, expensive language model calls per action and poorly designed community tools often lead to features too laggy for users.

Compounding Errors: Widely recognized as the primary risk in AI, hallucinations and errors increase the more LLMs are called as part of a complex action. This compounding effect often renders complex AI features unusable.

As AI adoption accelerates, these problems are intensifying. It is predicted that by 2026, over 30 percent of new API demand will come from AI and LLM tools. Integration problems threaten to bottleneck AI's real-world impact across organizations.

### SUMMARY OF THE DISCLOSURE

Embodiments of the disclosure provide system, methods, and one or more computer-readable media for processing requests in an AI environment. According to embodiments of the disclosure, the system includes an orchestration engine. The engine may be separate from the platform of a client application that provides a client request based upon a user request from a user. According to embodiments of the disclosure, the engine receives the client request, and provides a model request, based upon the client request, to a first model (e.g., LLM). According to embodiments of the disclosure the engine 109 receives, from the first model, a structured response based upon the model request. According to embodiments of the disclosure, the engine causes tool-function execution of one or more tool functions based upon the structured response. The engine may provide the execution result to the client application.

According to embodiments of the disclosure, the structured response includes respective identifications of the tool functions, and respective arguments for tool functions, which may be predicted by the first model. For execution, the engine may supply the arguments to actors for executing the tool functions. The system may include the actors. The actors may include an email actor, an enterprise collaboration actor, a math actor, a weather actor, or a cloud computing platform actor.

Instead of directly providing the execution result to the client application, the engine may provide the result to a second model that may be the same as or different from the first model, and receive from the second model a second result (e.g., a natural language summary), based on the result. The engine may then provide the second result to the client application.

If authorization is required for execution of a tool function by a service provider, the engine may provide, to the client application, information to enable access (e.g., authorization URL) to the service provider, according to embodiments of the disclosure. The engine may receive an indication of access permission (e.g., a token) for access to the corresponding service provider, where the access permission indication enables execution of the tool function.

According to embodiments of the disclosure, the access permission indication is received during a current session, enabling execution of the tool function based on a subsequent client request associated with the user.

According to embodiments of the disclosure, receiving the access permission indication comprises receiving the access permission indication from a corresponding authorization provider via a remote server in which the engine does not reside.

According to embodiments of the disclosure, the engine may receive a second client request associated with the user from the client application, and receive a second structured response from a third model that may be the same as or different from the first model. According to embodiments of the disclosure, the second structured response is based upon the second client request. Based upon the access permission indication, the engine may enable execution of the tool function based upon the second structured response.

The engine may select the first model based upon performance of the first model. The engine may determine a context based upon the client request, and provide the context to the first model. The first model may select the tool functions based upon the context.

For error handling, the engine may, based upon the structured response from the first model, provide a modified model request to a second model that may be the same as or different from the first model. The modified model request may be provided in response to a validation error in the structured response, or in response to an error in tool function execution. The service provider may provide an indication of the tool function execution error.

To evaluate tools for request processing, an evaluation framework may provide, based on the structured response, a score indicating performance of the first model's tool calling capability. For example, the structured response may include a first argument predicted by the first model, and the corresponding score may be based upon comparing the first argument to an expected argument. The structured response may include a first tool function name predicted by the first model, and the corresponding score is based upon comparing the first tool function name to an expected tool function name.

For each tool function and each argument, the framework may provide evaluation classifications based upon a comparison of the score to one or more thresholds, which may be adjustable. The framework may compute a composite score for the structured response based upon the scores for the tool functions and the arguments.

The framework may determine the score based upon a comparison of tool function calls in the received structured response with combinations of expected tool function calls.

The framework may compute a statistical score indicating performance of the first model's tool calling capability based upon corresponding scores for structured responses following two or more executions of providing model requests, receiving structured responses, and providing corresponding scores.

According to embodiments of the disclosure, the model request comprises second tool information in a format compatible with the first model, the second tool information is a translation of first tool information, and the second tool information is provided by the engine based on the first tool information. The first tool information may be provided by a developer using an SDK associated with the engine. The engine may determine the second tool information by translating the first tool information.

### BRIEF DESCRIPTION OF THE DRAWINGS

FIG. 1A depicts a system of embodiments of the disclosure in an ecosystem for executing tools with models.

FIG. 1B depicts an orchestration engine, according to embodiments of the disclosure

FIG. 2 is a sequence diagram illustrating processing of a tool that does not require authorization, according to embodiments of the disclosure.

FIGS. 3A-B (stitched together) are sequence diagrams illustrating processing of a tool that requires authorization, according to embodiments of the disclosure.

FIG. 4A shows a conventional tool calling interaction between a client application and a model.

FIG. 4B shows a tool calling interaction between a client application and a model, according to embodiments of the disclosure.

FIGS. 5A-5C (stitched together) depict an example tool for sending a DM to a user, according to embodiments of the disclosure.

FIG. 6 illustrates an example of a computer system that may be used to implement embodiments of the disclosure.

FIGS. 7A-B (stitched together) depict a sequence diagram for error handling, according to embodiments of the disclosure.

FIGS. 8A-8D depict a tool definition in various formats, including a universal format, according to embodiments of the disclosure.

FIGS. 9A and 9B are examples of code used for tool evaluation, according to embodiments of the disclosure.

### DETAILED DESCRIPTION

The present description is made with reference to the accompanying drawings, in which various example embodiments are shown. However, many different example embodiments may be used, and thus the description should not be construed as limited to the example embodiments set forth herein. Rather, these example embodiments are provided so that this disclosure will be thorough and complete. Various modifications to the exemplary embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein. Embodiments of the disclosure provide tool-calling capability, including authenticated and authorized workflow, that permits developers to enable AI to perform real-world actions, creating AI apps that go beyond chat. Some of the benefits include:

Authentication: Embodiments of the disclosure enable management of authentication protocols such as OAuth, API keys, and user tokens, eliminating a block to many everyday use cases that require secure integration of authenticated services.

Improved performance and uptime: Embodiments of the disclosure provide tools that deliver responses up to 70% faster than conventional technology, and may run in parallel. Embodiments of the disclosure offer built-in features like retry logic, tool routing, comprehensive logging, and failover mechanisms.

Improved AI reliability: Embodiments of the disclosure provide tool control mechanisms and smart parameter design that significantly reduces AI hallucinations and improves tool selection, addressing one of the biggest concerns in AI adoption.

Deployment: Embodiments of the disclosure may be deployed in the cloud or on-premises, meeting a range of enterprise needs and compliance requirements.

The present disclosure permits expansion of existing models (e.g., genAI LLMs) by including features such as tool execution, authorization for access to authenticated services like Gmail, and enhanced tool features and authoring capabilities.

In this disclosure, tools provide specialized functions that extend AI capabilities beyond text processing, allowing the models to perform specific tasks or access external information. According to embodiments of the disclosure, tools can interact with APIs, access databases, execute code, perform calculations, and retrieve real-time data.

Models (e.g., genAI LLMs) of the disclosure use tools through “tool-calling” or “function-calling.” A “tool call” refers to a mechanism that allows an AI model to invoke external functions or tools to enhance its capabilities. Some points about conventional tool calling in AI include:

Tool calling (also known as function calling) enables AI models to request specific information or actions from external sources, extending their capabilities beyond their trained knowledge, and interacting with external systems, APIs, or databases.

The AI model is provided with a set of predefined tools or functions it can use. When processing a query, the model can choose to select one of these tools. The model generates structured data (usually JSON) specifying the tool to use and its parameters. Conventionally, the actual execution of the tool is handled by the external system, not the AI model itself. Unlike conventional systems, embodiments of the disclosure enable the AI system itself to select and execute tool functions via interaction with an LLM (for example, without participation of the client application).

Different AI platforms and models have their own implementations of tool calling. For example: OpenAI's GPT models use a system called “function calling” (recently renamed to “tool calling”), and Google's Vertex AI refers to “tool calling” as “function calling” or “tool use.”

Conventional tool calls typically involve the model generating structured data (e.g., JSON) rather than a natural language output. Conventional AI systems do not execute the functions; they only specify which function should be called with what parameters.

### Use Cases

Two examples help demonstrate the tool calling capabilities of embodiments of the disclosure:

### Example 1: Simple Tool-Calling

Conventional AI language models are proficient at conversation, but not at math. They often hallucinate.

### Example 1: Math

User Query to LLM model: “What is the square root of 213,481,321?”

Processing: Instead of letting the LLM guess the answer, embodiments of the disclosure intercept the question and send it to a pre-built math integration tool.

### Tool Execution:

Embodiments of the disclosure run a pre-built “square root” calculator from its math toolkit.

It computes the correct and precise answer: 14,611.

Response: The LLM receives and uses this result to respond, “The square root of 213,481,321 is 14,611.”

Conventional LLMs provide the correct answer occasionally, but inconsistently. Embodiments of the disclosure guarantee accuracy every time.

### Example 2: Agent Authentication and Authorization

It is nearly impossible for conventional AI assistants to securely access personal email accounts due to complex authentication requirements and privacy concerns.

User Query to LLM model: “Any important emails from my wife today?”

Processing: The LLM query is intercepted by embodiments of the disclosure.

Tool Selection: Because this is a complex action, embodiments of the disclosure select multiple tools to check contacts, retrieve emails, assess importance, and filter by sender and date.

Secure Authentication and Authentication: Embodiments of the disclosure handle the secure OAuth flow and store the user tokens.

Tool Execution and Secure Data Retrieval: Embodiments of the disclosure identify the wife's email address, access Gmail, retrieve the wife's emails, filter the retrieved emails, and attach only the relevant email data to the message sent to the LLM. The LLM never sees the full inbox or raw email content.

AI Response: The LLM provides an accurate, real-time summary: “You have 2 important emails from your wife today.”

These examples show how the AI of embodiments of the disclosure can securely navigate multi-step processes with real-world systems and data.

### Structure and Operation

### Engine

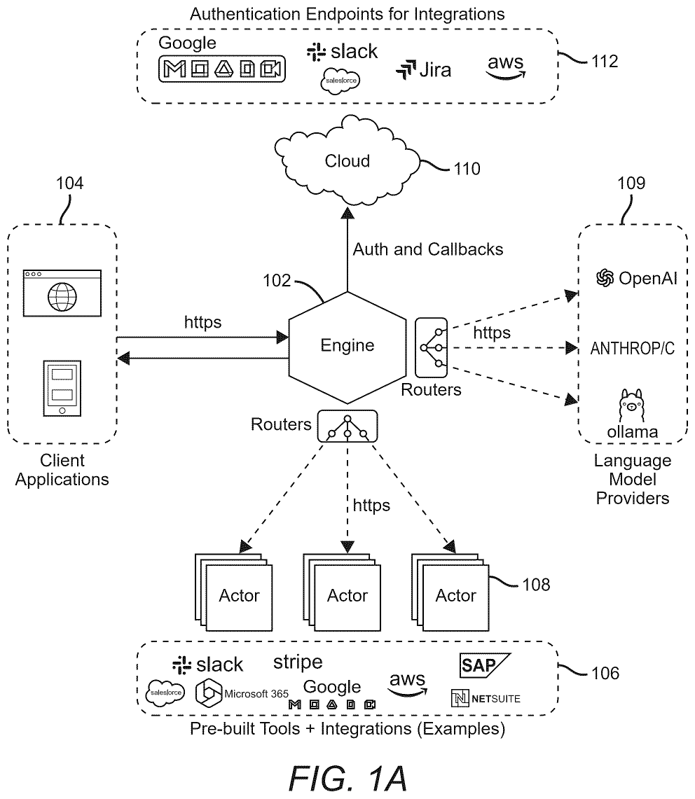

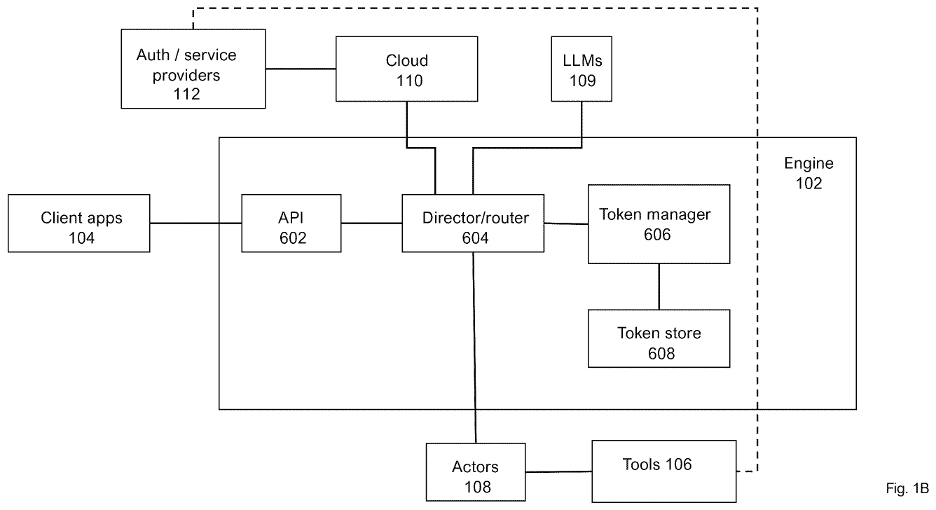

With reference to FIGS. 1A and 1B, embodiments of the disclosure provide an engine 102 that is a middleware layer (e.g., written in Go) that serves as an intermediary between client applications 104 and services 112. The engine 102 enables tool calling, allowing developers to execute tools in-flight during a request to an LLM. According to embodiments, the engine 102 may be executable on the client platform or on a separate platform.

### Main Engine Components

API: FIG. 1 B illustrates the engine 102. An API 602 of embodiments of the disclosure directly mimics LLM specifications (such as the OpenAI API specification), allowing developers to use existing LLM client libraries or raw HTTP requests for compatibility with any language. This flexibility enables developers to leverage the power of multiple, different LLMs 109.

Director/router: Block 604 represents the combined functionality of a director and a router. A director communicates with registered actors 108 to execute tools 106. When a request contains tool calls, the director 604 handles the execution of those tools by interacting with appropriate actors 108. Note that the terms “tools” and “tool functions” are used interchangeably herein.

A router may select an LLM 109 for processing requests based on LLM 109 performance (e.g., response quality, latency, failover). After an LLM 109 selects a tool and predicts tool arguments or provides other output for used by the director, the router routes the LLM 109 output back to the director. For the sake of convenience, “director” may refer herein to the combined “director/router 604.” According to embodiments of the disclosure, the director itself, aside from the router, performs all engine functions except one or more of token management, routing, and API functions.

In FIG. 1A, routers are shown outside the engine 102, but they may alternatively be inside the engine 102, as shown in the FIG. 1B. In FIG. 1B, the functionality of the routers (as depicted in FIG. 1A) is combined with that of the director 604.

Actors 108: Actors 108 are used to serve and invoke tool functions 106 (via, e.g., statelessly over HTTP servers or GRPC) that may be defined by a customer and that adhere to the actor API specification. Embodiments of the disclosure provide functionality to quickly spin up an actor (e.g., a compliant HTTP server) using a language such as Python. Actors 108 also communicate with the cloud service 110 and the engine 102 to coordinate tool usage, tracking, versioning, and deployments. Actors 108 may be registered with the director 604. Although FIGS. 1A and 1B shows the actors 108 outside the engine 102, they may reside within the engine 102.

### Engine Deployed as Cloud Service

According to embodiments of the disclosure, the engine 102 may be implemented as a cloud service, providing a managed and scalable solution for customers. This option is suitable for organizations that prefer a hosted solution without the overhead of managing infrastructure.

### Engine On-Premises Deployment (In-Customer VPC)

For enterprises with strict data privacy and security requirements, the engine 102 may be deployed within the customer's Virtual Private Cloud (VPC). This deployment model ensures that sensitive data remains within the enterprise's environment, providing greater control and compliance with internal policies.

Embodiments of the disclosure provide containers and binaries for the engine 102, allowing developers to use the engine 102 locally during development and testing phases, as well as for on-premises production deployments.

### General Operation

Embodiments of the disclosure provide a system for processing user-initiated requests using a model (e.g., an LLM). A client application 104 generates a client request based upon the user request. According to embodiments of the disclosure, the system includes an engine 102 that receives the client request. The engine 102 may include an API 602 that receives the client request and passes it on to the the director 604. The director 604 may, in turn, translate the client request into a model request having a format compatible with a format used by selected LLM 109. According to embodiments of the disclosure, the compatible format is a “universal format” that may be converted into a model-specific format, as described elsewhere herein.

As noted above, the engine 102 may select an LLM 109 (e.g., GPT-4, Claude 3, LlaMA 3.1, Gemini 1.5, etc.) based upon performance (e.g., latency) of the LLM 109, and provide the model request to the LLM 109. According to embodiments of the disclosure, the LLM 109 provides to the engine 102 a structured response based upon the model request.

The LLM 109 may select tool function(s) 106 based upon a context (e.g., client location, organization) of the client request. The LLM 109 may also predict arguments for the tool function(s) 106 for use by actor(s) 108 in executing the tool function(s) 106. The structured response from the LLM 109 may include identifications of the tool function(s) 106 and the arguments. Note that a single request, such as “email my wife,” may cause execution by the actors of multiple tools, e.g., a contacts tool to determine the identity of the user's wife, and then execution of an email tool to send the email.

According to embodiments of the disclosure, the engine 102 sends the execution results to the client application 104. Alternatively, the engine 102 may execute a generate function in which the engine 102 uses the same or a different LLM 109 to generate and send to the client application 104 another, more user-friendly response (e.g., a natural language response) based upon the results of the tool execution.

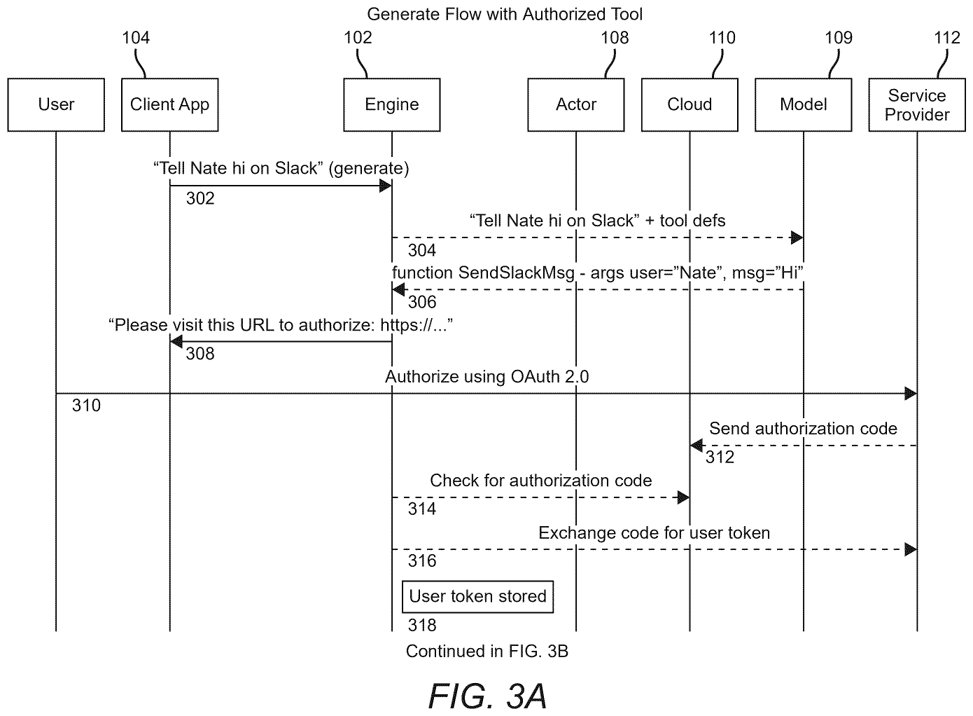

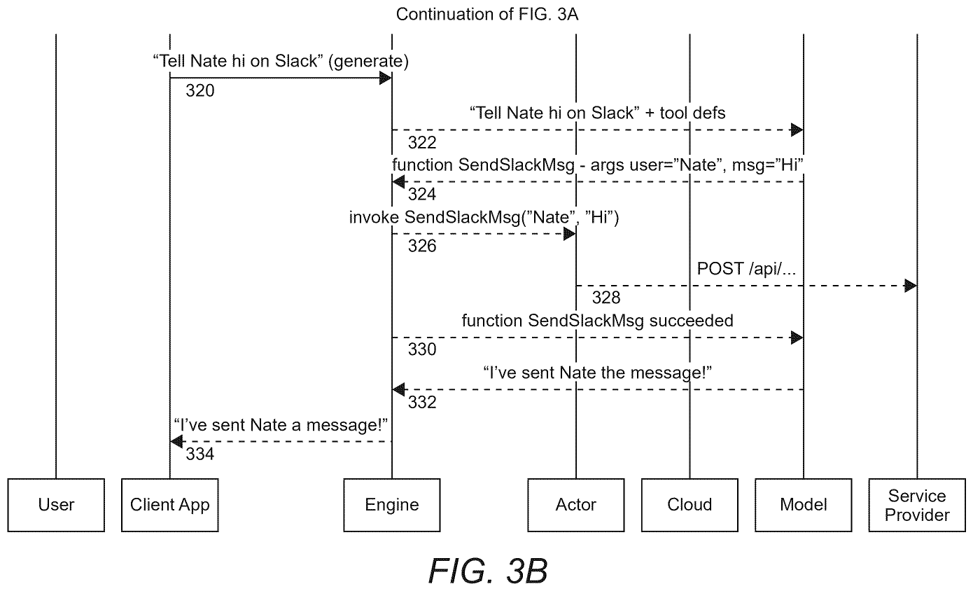

According to embodiments of the disclosure, the engine 102 enables execution of a client request that requires authentication and authorization to access the service provider 112. In the example of FIGS. 3A-B, the service provider 112 may include an “authorization provider.” Thus, in these examples, the terms are interchangeable. However, in other embodiments, the service provider and the authorization provider functions may be separate. (If separate, the authorization steps of FIGS. 3A-B (e.g., 310, 312, 314, 316) would be performed instead by an authorization provider separate from the service provider.) The AI system of embodiments of the disclosure handle authentication and authorization in the same manner. Therefore, as a matter of convenience, the term “authorization” may be used herein to also refer to authorization and authentication, and those terms may be used interchangeably herein.

For authorization of each of the tool functions, the engine may:
receive an indication that authorization is required to execute the tool function;
initiate an authorization challenge for the authorization provider 112;
generate an authorization URL in response to an authorization code provided by the authorization provider 112; and
provide the authorization URL to the client application 104.

In response to the authorization URL, the user may enter their credentials to provide permission to access the authorization provider 112. In response, the engine 102 receives an indication of access permission (e.g., authorization code) for access to the authorization provider 112. According to embodiments of the disclosure, execution of the tool function is based upon the access permission indication.

The engine 102 may employ a token manager 606 to manage tokens used for authorization. In response to user authorization, the authorization provider 112 provides an access token. Then, the token manager 606 may associate the token with the access permission indication, and store the token in token store 608, or, alternatively, in separate storage outside the engine 102.

The engine 102 may check for the existence of that token to enable authorization of a later request that employs the same service provider 112. Thus, the access permission indication may be based upon (a) user authorization during a session or (b) presence of a pre-existing access token.

After access is granted, the client application 104 may resend the client request to the engine 102. This time, the service provider will provide access and enable execution of a tool function 106 corresponding to the service provider 112.

The system may employ a remote server in the cloud 110 to act as an intermediary between the engine and the authorization provider 112. In that case, communication with the authorization provider 112 for the authorization challenge and receipt of the access permission indication (e.g., authorization code) is conducted via the cloud 110.

Examples: Without and with Authorization Required

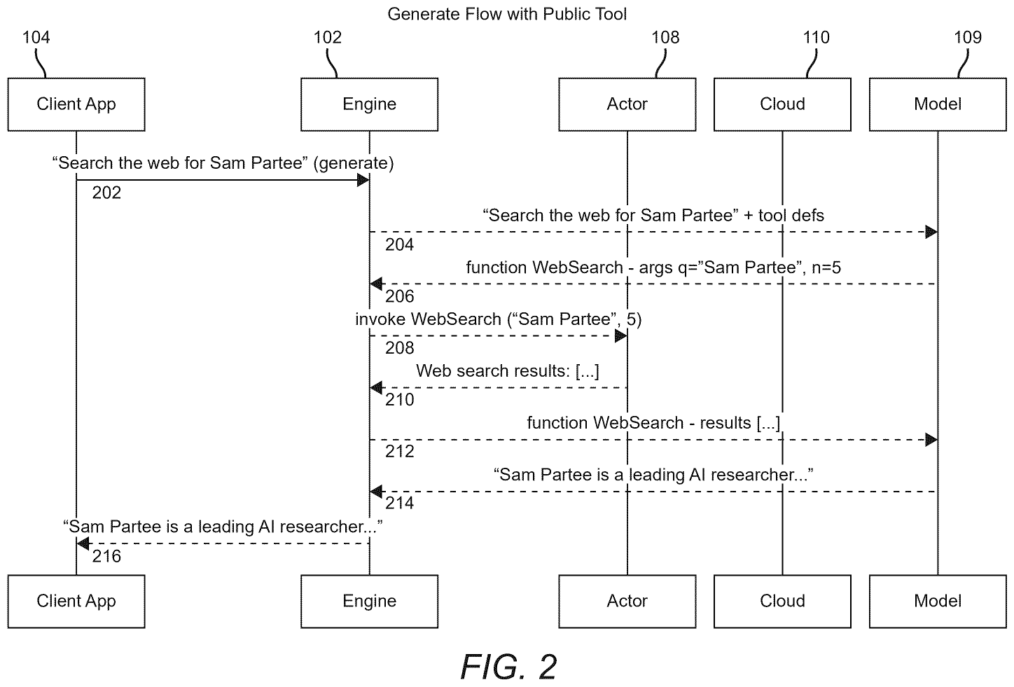

FIGS. 2 and 3A-B depict sequence diagrams to illustrate the following examples of embodiments of the disclosure:
1. Example of using a tool that does not require authorization (Google search)
2. Example of using a tool that does require authorization (Slack)

### Example 1: Public Tool Flow (Authorization not Required)

In FIG. 2, in response to a user request to search the web for Sam Partee, the client application 104 sends a request “Search the web for Sam Partee” to the engine 102 (step 202).

In response to the client request, the engine 102 generates a model request.

### Universal Tool Definition Format

According to embodiments of the disclosure, the system employs tool definitions. A tool definition generally may have one field identifying the tool function and multiple parameter fields for specifying arguments, including, for the tool function and each parameter, a description (e.g., annotations explaining the nature and use of the tool or parameter), and a type (e.g., character string, boolean, integer).

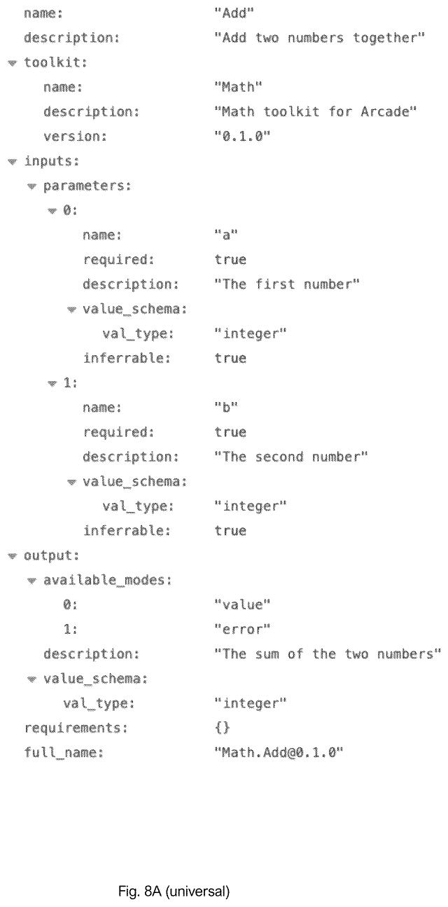

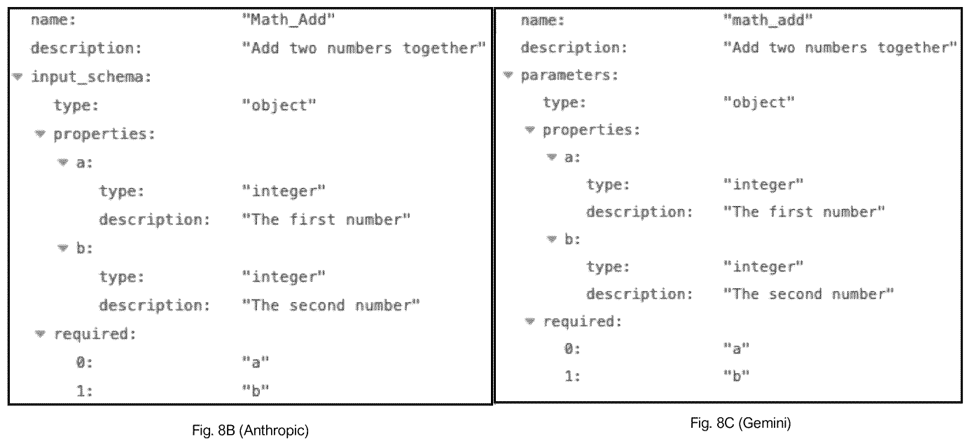

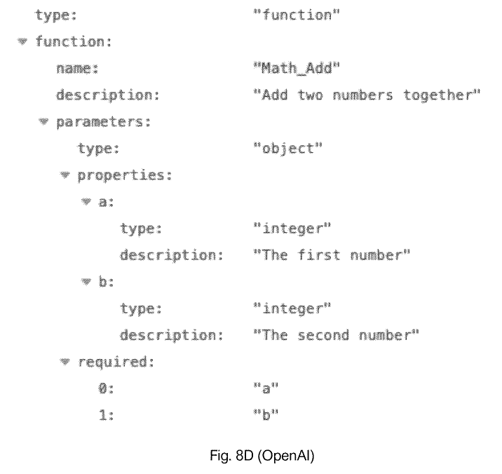

Referring to FIGS. 8A-8D, according to embodiments of the disclosure, the engine 102 may convert the format of a tool definition that has been coded in a “universal” format (FIG. 8A) compatible with the director 604 to model-specific formats (FIGS. 8B-8D). For example, the engine 102 may include a translator to translate the tool definition from the universal format into a format compatible with the selected model 109. The translator may act in a manner similar to the GCC (GNU Compiler Collection), which ingests code written in a specific programming language (e.g., C, C++, Fortran), and translates it into machine code or another format suitable for execution on different operating systems and architectures.

Like GCC, the translator may process the tool definition, which may include reformatting actions like expanding function code, adding headers, and reformatting syntax, into an intermediate representation (IR). Similar to GCC, the translator may then format the IR tool code into a tool code compatible with the specified model 109. The IR is a representation of a specification generalized to the multiple LLM formats, allowing the translator to optimize it across the different LLM 109 formats.

According to embodiments of the disclosure, the router in the director/router 604 may translate the tool definition IR into a format compatible with the target LLM 109. For example, the generalized (“universal”) tool definition code shown in FIG. 8A for the Math.Add@0.1.0 function in the universal format may be translated into respective formats (FIGS. 8B-8D) specific to tool definitions used by Anthropic (FIG. 8B), Gemini (FIG. 8C), and OpenAI (FIG. 8D). Note that each parameter in the universal format includes a true/false flag for “inferrable” to indicate to the LLM 109 whether it should try to predict the parameter.

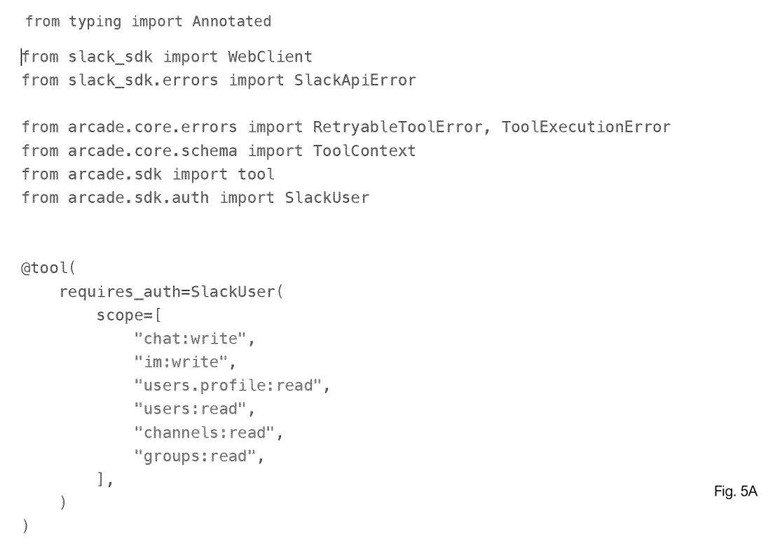

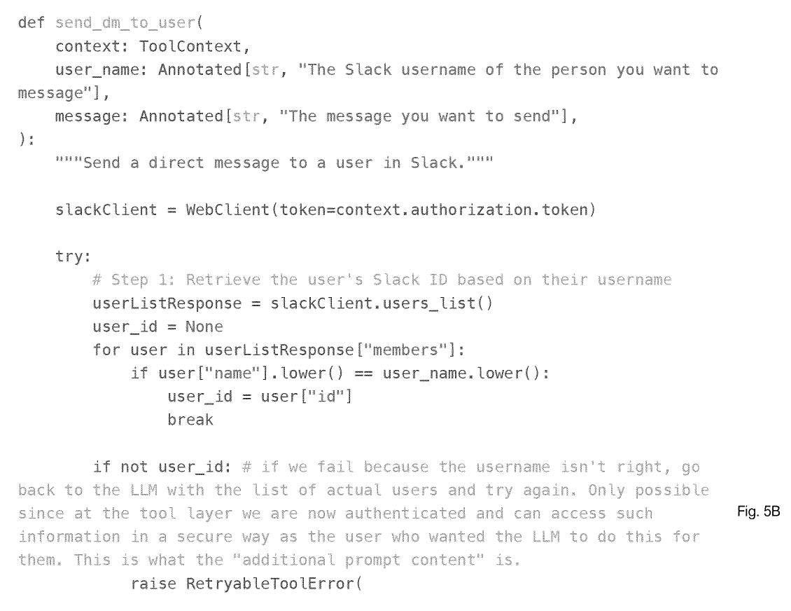

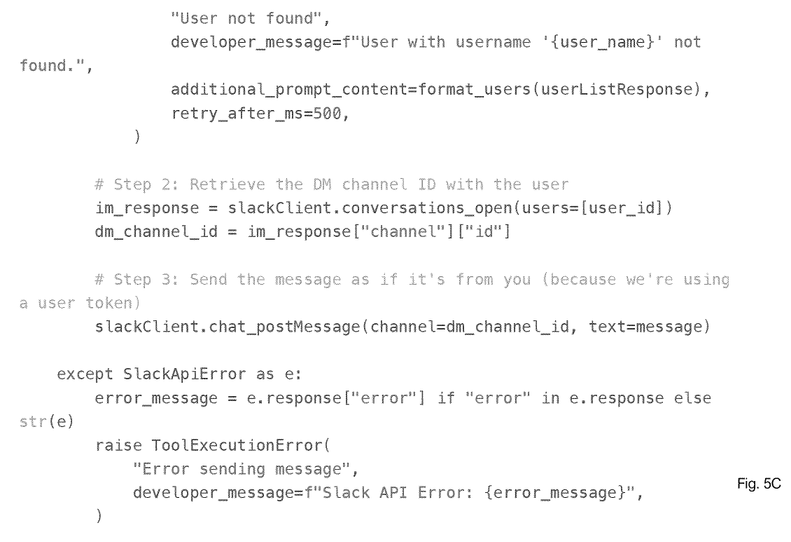

According to embodiments of the disclosure, each actor 108 is loaded with tool definitions that may be different from the tool definitions stored by other actors 108. During startup, the engine 102 may receive the tool definitions from the actors 108. The tool SDK example below, as well as FIGS. 5A-5C, show an actor tool SDK created by a tool developer.

The engine 102 may look up the tool definitions (e.g., in JSON schema at this stage) available at the engine 102 and add, in some embodiments, the tool-specific definitions to the model request. Note that in later steps (discussed below), a selected LLM 109 will predict the parameters for the tool definition, insert them in the JSON schema of the tool definition, and send back the resulting JSON to the engine 102.

### Tool SDK

The Tool SDK, which may be developed in Python, assists developers in the creation of tools for LLM usage. The SDK introduces an opinionated, yet standard library-compatible specification for definition of functions. These opinions are constraints imposed in the manner a compiler imposes syntax for a language. However, instead of compilation to machine code or binary, the SDK is for conversion in a tool definition specification of embodiments of the disclosure. The tool definition itself may itself be a JSON specification. While the tool specification can be generated by the SDK to ease developer experience, any HTTP server adhering to the actor specification (e.g., written in haskell) may serve LLMs tools according to embodiments of the disclosure.

Note that the tool SDK also provides components for authorization specification. For example:

@tool( #specifies to Arcade that this is a Tool
requires_auth=Google( # tells Arcade Engine to trigger OAuth for google
scope=[“https://www.googleapis.com/auth/calendar”], # with scopes
)
)
async def list_events(
context: ToolContext, # the struct within which the user token and id is
passed to the tool.
calendar_id: Annotated[ # example of opinioned Tool formatted
str, “The ID of the calendar to list events from” # desc for LLM
] = “primary”,
date_range: Annotated[
DateRange, “The date range for which to list events”
] = DateRange.TODAY,
max_results: Annotated[int, “The maximum number of events to return”] =
10,
) −> Annotated[str, “A JSON string containing the list of events”]:
“““List events from the specified calendar within the given date
range.”””

Next, engine 102 (director/router 604) passes the model request to the model 109 (204)—(“Search the web for Sam Partee”+tool defs). The engine 102 may send to the model 109 all or a subset of the tool definitions it has to assist the model 109 in selecting the tool function. If just a subset is sent, each subset may represent a different logical grouping (e.g., weather tools, finance tools, customer support) specified in the client request, e.g., by identifying an actor which includes tools associated with a desired logical grouping.

In response, the model 109 selects a tool function and infers arguments for the tool function. The model 109 responds to the engine 102 with the tool function and arguments to enable execution of a WebSearch (206)—(function WebSearch—args q=“Sam Partee”, n=5).

In response, the engine 102 selects the actor 108 that serves the selected tool, and, using the tool definition with the predicted arguments, invokes execution of the WebSearch by the selected actor 108 (208)—(invoke WebSearch (“Sam Partee”, 5)). For more details on this step, see the summary of Execute Communication below.

The actor 108 returns the search results to the engine 102 (210)—(Web search results: [ . . . ]).

To translate the search results to natural language, the engine 102 sends the search results to the model 109 (212)—(function Web search results: [ . . . ]), which returns the natural language results to the engine 102 (214)—(“Sam Partee is a leading AI researcher . . . ”). The engine 102 passes the natural language results back to the client application 104 (216)—(“Sam Partee is a leading AI researcher . . . ”). For more details on this step, see the summary of Generate Communication below.

### Example 2: Tool Authorization Flow (Authorization Required)

FIGS. 3A-B illustrate an example of a request that requires authorization. The engine 102 leverages a cloud 110 to handle the authorization flow for tools 106 called through the API of the LLM 109. This approach allows models 109 to securely call authenticated endpoints on behalf of the end-user. According to embodiments of the disclosure, the authorization process of FIGS. 3A-B follows these steps:

A user requests that a message be sent to a coworker over an enterprise collaboration tool (e.g., Slack) (step not shown). In response, the client application 104 sends a greeting message request “Tell Nate hi on Slack” to the engine 102—(“Tell Nate hi on Slack” (generate)). (302)

In response to the client request, the engine 102 generates a model request. According to embodiments of the disclosure, the engine 102 looks up a tool definition (e.g., JSON specification) supplied at engine startup by an actor 108, and adds the tool definition to the model request. Alternatively, the engine 102 may receive the tool definitions from the client request. Engine 102 (director 604) passes the model request to the model 109 (304)—(“Tell Nate hi on Slack”+tool defs).

In response, the model 109 selects a tool function and infers arguments for the tool function. The model 109 responds to the engine 102 with an identification of the tool function and inferred arguments to enable the sending of a Slack message (306)—(function SendSlackMsg-args user=“Nate”, msg=“Hi”).

The director 604 checks authorization specifications provided in the tool to determine if authorization is required. For example, in the Tool SDK section, the list_events tool function code includes code that indicates authorization is required to access Google:

$$requires\_auth = Google ( \# tells Arcade Engine to trigger OAuth for google$$

If authorization is required, the director 604 creates an authID based on the user_id, tenant_id, organization_id, and the authorization provider 112. The director 604 checks the authorization status for the authID with a token manager 606. If the token manager 606 indicates that the authorization status is pending or failed, the director 604 initiates a new authorization challenge: The director 604 generates a unique state value and retrieves the OAuth callback URL from the cloud 110. In this example, OAuth is used for authentication. In other embodiments, any suitable process may be used for authentication. The director 604 calls the StartAuthorizationChallenge method of the appropriate authorization provider 112 type (e.g., Google, Slack, GitHub App). The authorization provider 112 generates an authorization URL and starts listening for the callback from the cloud 110.

The engine 102 sends to the client application 104 a message directing it to the authorization URL to prompt user authorization (308)—(“Please visit this URL to authorize: https:// . . . ”).

The user sends an authorization message using OAuth 2.0 directly to the authorization provider 112 (310)—(Authorize using OAuth 2.0), which, in turn, provides an access token if authorization succeeds.

In response, the service provider 112 sends an authorization code to the cloud 110 (312)—(Send authorization code).

The cloud 110 may notify the token manager 606 about the successful authorization (not shown).

The engine 102 checks with the cloud 110 for an authorization code (314)—(Check for authorization code). If the code exists, in some embodiments, the token manager 606 in the engine 102 exchanges the authorization code for the token (316)—(Exchange code for token), and stores the user token in the token store 608 (318).

In some embodiments, the client application 104 retries sending the request to greet Nate on Slack (320)—(“Tell Nate hi on Slack” (generate)).

In response, the engine 102 resends the request along with tool definitions to the model (322)—(“Tell Nate hi on Slack”+tool defs).

In response, the model 109 selects a tool function and infers arguments for the tool function. The model 109 again responds to the engine 102 with the tool function identification and inferred arguments (324)—(function SendSlackMsg—args user=“Nate”, msg=“Hi”). According to embodiments of the disclosure, the model 109 may retrieve the tool function identification and inferred arguments from cache in which that data was stored after the previous request processing (e.g., 304).

The director 604 can now execute the tool using the acquired credentials and permissions associated with the user_id. The engine 102 (director 604) invokes execution of the tool function by the actor 108 (326)—(invoke SendSlackMsg (“Nate”, “Hi”)). The actor notifies the service provider 112 (Slack) via a POST message to send the greeting message to Nate (328)—(POST/api/ . . . ).

To translate the result into natural language, the engine 102 sends an indication to the model 109 that the execution was successful (330)—(function SendSlackMsg succeeded). The model returns to the engine 102 the plain English message “I've sent Nate the message!” (332).

The engine 102 includes the plain English tool result in a response and returns it to the client application 104 (334)—(“I've sent Nate the message!”).

### Authorization Via Cloud

According to embodiments of the disclosure, the cloud 110 acts as an intermediary for handling the OAuth callback and token exchange during the tool authorization process. It enables the engine 102 to securely execute authenticated tools on behalf of end-users.

The primary responsibilities of the cloud 110 in the tool authorization flow include:

OAuth callback handling: When the engine 102 initiates an authorization challenge for a tool, the engine 102 generates an authorization URL conforming to the authorization provider 112 (e.g., Google, Slack, GitHub App). The engine 102 then notifies the cloud 110 to start listening for a callback (e.g., auth code) from the service provider 112, which is received after the service provider 112 authorizes the app. The engine 102 checks with the cloud 110 for the authorization (e.g., auth code).

Token management: The token manager 606 in the engine 102 exchanges the authorization code for an access token and stores it in a secure token store 608.

Configuration management: The cloud 110 provides the necessary configuration details to the engine 102, such as the OAuth callback URL, which is required for initiating the authorization challenge.

This authorization flow thus leverages the cloud 110 as a trusted intermediary for handling the OAuth callback and token exchange. Separating the callback logic from the engine 102 allows the engine 102 to remain within the customer's private VPC while still allowing LLMs to securely call authenticated endpoints on behalf of the end-user. This keeps the authorization process transparent and simplifies the integration of LLM tool-calling into applications.

Tool Authorization Flow Example with CURL

This example shows an interaction between a client application and the engine for a request for emails.

Section 1: Set up environment variables

# Set the Arcade Engine API key
export
ARCADE_API_KEY=“arc_o1DULJcrhDibygqH2MsNfC4G0eChLMU9jasBcb8dVyzave6bJyV
h”
# Set the user ID (unique identifier for the user)
export USER_ID=“user_123”

In this section, the example has set up two environment variables:
1. ARCADE_API_KEY: This is the API key provided by the engine 102, which is required for authentication when making requests to the engine API 602.
2. USER_ID: This is a unique identifier for the user, which is used by the engine 102 to associate the user with the appropriate authentication credentials and permissions. This comes from the customer (the client).
Section 2: Send an initial request to call the Gmail tool

```
curl https://api.arcade.xyz/v1/chat/completions \
  -X POST \
  -H “Content-Type: application/json” \
  -H “Authorization: Bearer $ARCADE_API_KEY” \
  -d ‘{
    “model”: “gpt-3.5-turbo”,
    “messages”: [
      {“role”: “system”, “content”: “You are an assistant that can use
tools.”},
      {“role”: “user”, “content”: “Please use the Gmail tool to read my
emails”}
    ],
    “user”: ‘““$USER_ID””’.
    “tools”: [“Google.ListEmails”]
}’
```

In this section, an initial request has been sent to the engine API 602 to call the “Google.ListEmails” tool, which is assumed to be a pre-defined tool for reading emails from Gmail. Each part of the command does the following:

1. curl https://api.arcade-ai.com/v1/chat/completions : This is the endpoint for the engine API
602 that handles tool calls.
-X POST : This specifies that a POST request is sent.
-H “Content-Type: application/json” : This sets the Content-Type header to
application/json, indicating that the request body is in JSON format.
-H “Authorization: Bearer $ARCADE_API_KEY” : This sets the Authorization header
with the engine API key, which is required for authentication.
5. -d ‘{ ... }’ : This is the request body in JSON format, which includes the following fields:
model : The name of the LLM model to use (in this case, gpt-3.5-turbo).
messages : An array of messages, including the system prompt and the user's request to use
the Gmail tool.
user : The unique identifier for the user ( $USER_ID ).
tools : An array of tool names to use (in this case, [“Google.ListEmails”] ).

Section 3: Handle the authorization flow

This is a terminal version of a client talking the user through the auth process when the client is not authorized to use the tool the LLM chooses.

# If the response includes an authorization URL, authorize the app
# The response will look like: {“choices”: [{“message”: {“content”: “Please
go to this URL and authorize the app: https://example.com/authorize”}}]}
# Extract the authorization URL from the response
AUTH_URL=$(echo “$RESPONSE” |jq -r ‘.choices[0].message.content’ | cut -
d‘:’ -f2- | xargs)
# Open the authorization URL in a browser
open “$AUTH_URL”
# Wait for the user to authorize the app
read -p “Press Enter once you have authorized the app...”

This section describes the authorization flow if the initial request requires the user to authorize the app:

| | |
|---|---|
| 1. | The response from the initial request is expected to include an authorization URL if the |
| | tool requires authentication. The response may look like: |
| | {“content”: “Please go to this URL and authorize the app: |
| | https://example.com/authorize”}}]} |
| 2. | The client application code uses the jq command to extract the authorization URL from |
| | the response JSON. |
| 3. | The client application can open the extracted authorization URL in a browser using the |
| | open command (this command may vary depending on the operating system). |
| 4. | The client application prompts the user to authorize the app by visiting the provided URL |
| | and press Enter once the user has completed the authorization process. |

Section 4: Retry the tool call after authorization

```
curl https://api.arcade-ai.com/v1/chat/completions \
  -X POST \
  -H “Content-Type: application/json” \
  -H “Authorization: Bearer $ARCADE_API_KEY” \
  -d ‘{
    “model”: “gpt-3.5-turbo”,
    “messages”: [
      {“role”: “system”, “content”: “You are an assistant that can use
tools.”},
      {“role”: “user”, “content”: “Please use the Gmail tool to read emails.”}
    ],
    “user”: ‘““$USER_ID””’,
    “tools”: [“Google.ListEmails”]
}’
```

In this section, the tool call has been retried after the user has authorized the app. The command is the same as the initial request in Section 2, but this time, the engine 102 should have the necessary credentials to execute the tool.
Section 5: Receive the tool result
# The response should now include the tool result (emails)

After the tool call is retried, the response from the engine 102 should now include the tool result, which in this case includes the emails.

### Tool Evaluation Framework

Embodiments of the disclosure provide a tool evaluation framework for evaluating the performance of models (e.g., LLMs) 109 in predicting the tool functions and arguments. The engine 102 may run the framework.

According to embodiments of the disclosure, the engine 102 can compare an expected structured response to a response from the model, based on a test request, to select the best performing tool functions and arguments for execution or best performing model (e.g., by sending the same test request to various models).

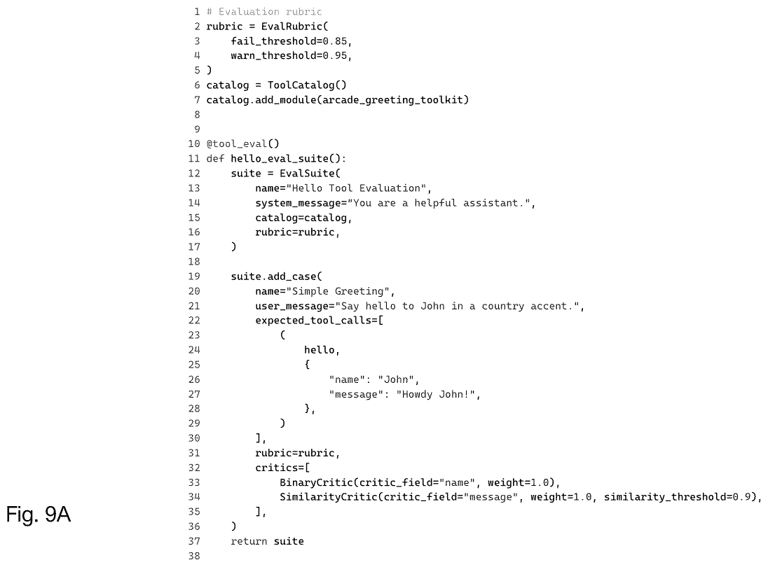

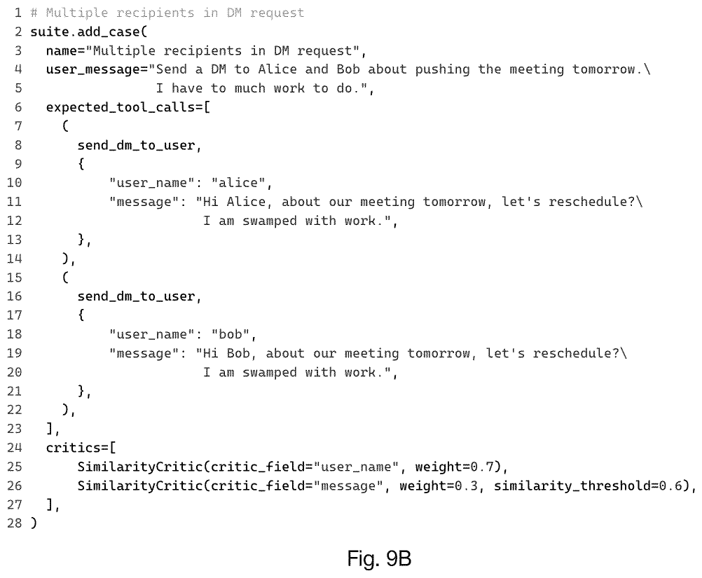

In the tool evaluation framework, a test user message and the expected tool call are specified—for example, see FIGS. 9A and 9B. The arguments in the structured response from the model 109 are compared to the arguments in the expected tool function to score the model's response to the test user message. In some embodiments, for example, if the test user message includes multiple targets (e.g., Alice and Bob), the expected tool calls may include combinations of the targets and corresponding messages (e.g., Alice/Alice message+Bob/Bob message; Bob/Bob message+Alice/Alice message) to properly score the response from the model 109.

For a comparison between character strings, the framework may use vector arithmetic, e.g., compute the vector distance (or cosine of the vector distance) between resulting words/sentences and expected words/sentences.

The result of the comparison may be compared to a threshold to classify the evaluation result (e.g., pass/fail) (a “binary critic” in the code of FIG. 9A). By using multiple thresholds, the framework may provide more classifications (e.g., pass/warn/fail) (a “similarity critic” in the code of FIGS. 9A and 9B).

The framework enables adjustment of the thresholds to adjust sensitivity of the score to each evaluated argument. The framework may weight each score, and use them to compute a weighted composite score for the performance of the model for the test user message. The framework may also compute a statistical score based upon the scores for the tool functions and the arguments for multiple executions of the same test request. The scores would likely vary due to the non-deterministic nature of the model predictions. The scores may be used as feedback for model, tool, or argument selection. As described elsewhere, the engine 102 may select the model 109 based upon performance (e.g., the score).

As shown in FIG. 9A, a first model request reads:
“Say hello to John in a country accent”

The LLM 109 predicts the tools and arguments based upon context of the model requests. This example includes only a single tool, and will evaluate only the argument prediction. Tool prediction would be handled in a similar manner.

In the example, the expected LLM response is:
user_name: John
message: “Howdy John!”

The evaluation framework scores the argument predictions from the LLM 109 by comparing them to expected arguments obtained from the universal tool definition format. In this example, assuming that the LLM predicts: user_name: John, message: “Hello John,” the predicted message “Hello John” is not identical to the expected message “Howdy John!”. Therefore, the score would not represent a 100 percent match.

FIG. 9B illustrates a test case for evaluating a compound request to send a message to two users, Alice and Bob. The test case includes a test model request and expected tool calls to be compared against structured responses from the LLM 109. The test model request reads: “Send a DM to Alice and Bob about pushing the meeting tomorrow. I have to [sic] much work to do.” The expected tool calls for that request are:

User name=Alice, msg=“Hi Alice, about our meeting tomorrow, let's reschedule? I am swamped with work.”

User name=Bob, msg=“Hi Bob, about our meeting tomorrow, let's reschedule? I am swamped with work.”

The tool function calls in the returned structured response from the LLM 109 may not arrive in the same order as the expected order of the Alice-Bob tool function calls based on the test model request. See, e.g., FIG. 9B. One might compute incorrect scores by comparing the tool function call for Alice to that for Bob, the the tool function call for Bob to that for Alice, etc.

Thus, the framework may score the tool function calls in the returned structured response against possible combinations of expected tool function calls. The framework may pick the correct score based upon the highest total composite score for the expected tool function call combinations, using, e.g., the Jonker-Volgenant variant of the Hungarian algorithm for solving linear sum assignment. In sum, the framework may determine the score based upon a comparison of tool function calls in the received structured response with combinations of expected tool function calls.

### Tool Calling Patterns

The communication pattern carried out by the engine-actor(s) system is determined by the arguments supplied by the user on the client side (e.g., with the OpenAI client or an HTTP request) according to embodiments of the disclosure.

The tool choice argument helps define which communication pattern will be used.

The following arguments for tool_choice are available:
a. auto: pick and call one or more tools
b. none: do not call a tool, just chat.
c. required: must call one or more tools. (just OpenAI)

Embodiments of the disclosure add support for two more choices:
a. execute: Acts like tool_choice-required, but actually executes the tool.
b. generate: Same as execute, but makes another request using a model to generate a string (e.g., sentence) response given the results of the tool execution.

Note that none will still be supported—in the engine it acts as a “noop” (no tools will be invoked).

The following describes the execute and generate functions in greater detail:

### Execute Communication

Execute is a way of making the legacy LLM seem as if it is capable of running the tool in addition to guessing the arguments. Because no second client connection, logic, or app code needs to be introduced to call the tool, addition of this function in embodiments of the disclosure simplifies the tool calling process (less client code necessary) and increases performance (fewer network hops and traffic especially when engine 102 and actor 108 are co-deployed).

### Steps:

1. Customer uses OpenAI client to call OpenAI model with the base addr specified as the engine 102 address.
   a. Arguments: tool_choice-execute and tools=MyFancyToolName
2. Engine 102 intercepts the Call to OpenAI produced by the customer's OpenAI client or HTTP call.
3. Engine 102 looks up the tool definitions supplied by the actor(s) 108 and adds them to the model (LLM) call (see Openai function calling:
https://platform.openai.com/docs/assistants/tools/function-calling/quickstart), replacing the tools parameter (tools-GetGoogleCalEvents) with a JSON blob of the tool schema that the particular model provider expects. The tool definition may be a custom-made API spec, or be open source so any developer can make actors 108 in any language. Engine 102 also changes the tool_choice-required (or tool_choice-auto or similar for non-openai providers that support different options).
4. The engine 102 can route requests to various models 109 (e.g., LLM services, including Anthropic, Ollama, Amazon Bedrock) capable of inferring LLM tool parameters. Given the model name, the engine 102 may use a router model-myRouter which communicates with whatever LLM 109 performs best, e.g., best fits its communication strategy (least-latency, health check, round robin, etc). The engine 102 directly looks up a model, e.g., model=openai-gpt-4) and warms a client connection.
5. LLM 109 used by the engine 102 predicts the tool to use based on the context passed from the customer through the engine 102. The LLM 109 also predicts the tool arguments.
6. Given the predicted tool name, tool version, and tool arguments supplied by LLM 109, engine 102 can route the tool execution request to various actor(s) 108 that can execute the tool. Given the tool name and version, the engine 102 may use a router model which communicates with whatever actor 108 is capable of executing the requested tool and that also performs best, e.g., best fits its communication strategy (least-latency, health check, round robin, etc.). The engine 102 obtains a lock on the actor 108 instance from a pool of pre-allocated engine-actor connections.
7. Engine 102 supplies the predicted tool call arguments to the actor 108 via an HTTPS (or similar protocol such as gRPC) request.
8. The actor 108 receives the request and executes the tool with the specified parameters predicted by the LLM 109.
9. After completion of the tool execution, the result of the tool call is sent back to the engine 102.
10. The engine 102 receives the tool execution results and places a string representation in the content field of the ChatResponse object.
11. The ChatResponse is then sent back to the customer client application 104.

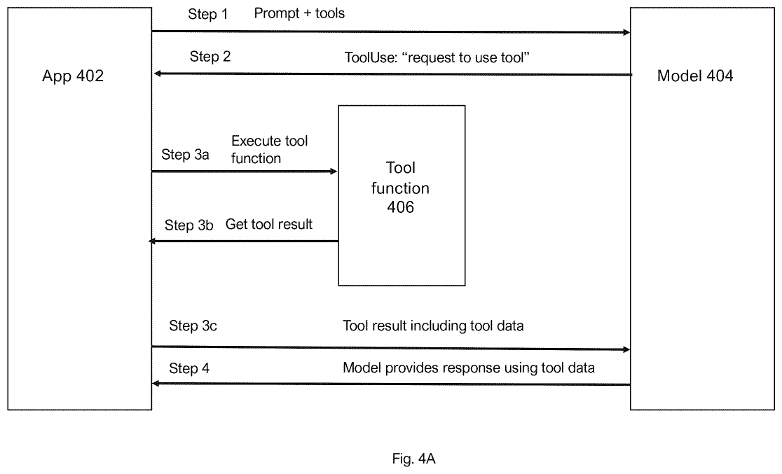

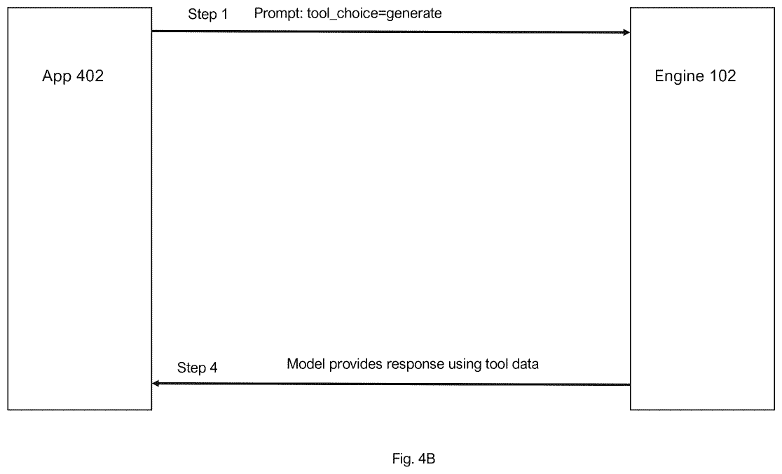

The execute function of embodiments of the disclosure provides advantages over conventional tool calling. FIG. 4A shows an interaction between a client application 402 and a conventional model 404, such as Anthropic's LLM. One notable difference between embodiments of the disclosure and the conventional model is that the conventional model (or an intermediary engine 102 between the client application and the model) does not handle tool execution for the client. Instead, the client bears that burden.

In FIG. 4A, the client application 402 code specifies the tool definitions, and sends the request to the conventional model 404 (step 1).

The conventional model 402 infers arguments for the tool and returns them to the client app (step 2).

The client application 402 is then responsible for executing the tool 406 with the inferred arguments (step 3a). The tool function 406 returns a tool result to the client application 402 (step 3b).

The client application 402 then sends the tool result to the model 404 (step 3c). The model 404 may formulate a response and send it to the client app. (step 4).

The conventional request handling of FIG. 4A requires two round trips from the app to the model to perform what the model of embodiments of the disclosure handles in one round trip, as shown in FIG. 4B.

FIG. 4B illustrates the client request with tool_choice=generate. Based on the more detailed discussion of the interaction sequence above, the interaction requires just a request (step 1) and a response from the engine 102 of embodiments of the disclosure (step 4).

The above comparison shows the efficiency of embodiments of the disclosure even without the benefit of the authorization features of embodiments of the disclosure. Moreover, the “set of tools” specified by the client application in FIG. 4A is relatively complicated JSON data that must exactly match the function definition required by the model, and be updated each time the functions are updated. In contrast, the model of embodiments of the disclosure relieves the client application of this burden, and utilizes the input of the tool developer and the tool translation capability described above.

Below is example of conventional client application code for step 1 of FIG. 4A to show tool management.

### Conventional Tool Calling:

```
‘‘‘python
import anthropic
client =
anthropic.Anthropic( )
response = client.messages.create(
model=″claude-3-5-sonnet-20240620″,
  max_tokens=1024,
  tools=[
    {
      ″name″: ″get_weather″,
      ″description″: ″Get the current weather in a given location″,
      ″input_schema″: {
        ″type″: ″object″,
        ″properties″: {
          ″location″: {
            ″type″: ″string″,
            ″description″: ″The city and state, e.g. San Francisco, CA″,
          }
        },
        ″required″: [″location″],
      },
    }
  ],
  messages=[{″role″: ″user″, ″content″: ″What's the weather like in San Francisco?″}],
)
print(response)
‘‘‘
```

In contrast, the following is example client application code for the embodiments illustrated by FIG. 4B:

```
‘‘‘
import arcade
client =
arcade.client.Arcad
e( )
response = client.chat.completions.create(
  model=“anthropic/claude-3-5-sonnet-20240620”, # use any model
  tools=[“get_weather″], # auto updated spec of the tool
  messages=[{″role″: ″user″, ″content″: ″What's the weather like in San Francisco?″}],
)
print(response)
‘‘‘
```

### Generate Communication

The above describes execution of a tool according to embodiments of the disclosure. Below is example code using the tool_choice=generate option. The generate option is similar to execute, but it adds an additional step where the engine 102 sends a second request to the LLM to generate a response (e.g., in natural language) based on the tool execution results.

### Steps:

1. Customer uses OpenAI client to call OpenAI model with the base addr specified as the engine address.
   Arguments: tool_choice-generate and tools-MyFancy ToolName
2. Engine 102 intercepts the call to OpenAI produced by the customer's OpenAI client or HTTP call.
3. Engine 102 looks up tool definitions supplied by the actor(s) 108 and adds them to the model (LLM) call, replacing the tools parameter with a JSON blob of the tool schema. Engine also changes tool_choice=auto.
4. LLM 109 predicts the tool to use based on the context passed from the customer through the engine 102, and predicts the tool arguments.”.
5. See Execute Communication Step 6.
6. See Execute Communication Step 7.
7. Actor 108 receives the request and executes the tool with the specified parameters.
8. After completion, the tool execution results are sent back to the engine 102.
9. Engine 102 receives the tool execution results and adds them to the ChatResponse object.
10. Engine 102 clears the tools and sets tool_choice=none in the ChatRequest.
11. Engine 102 adds the tool calls and results to the ChatRequest.
12. Engine 102 sends a new request to the LLM 109 with the updated ChatRequest containing the results of tool execution.
13. LLM 109 generates a response based on the tool execution results.
14. Engine 102 receives the generated response and adds it to the ChatResponse.
15. The ChatResponse is then sent back to the arcade customer client code 104.

The result is that the customer receives a generated response from the LLM 109 that incorporates the tool execution results, without needing to make any changes to the client application code.
Error handling—retriable tool calling

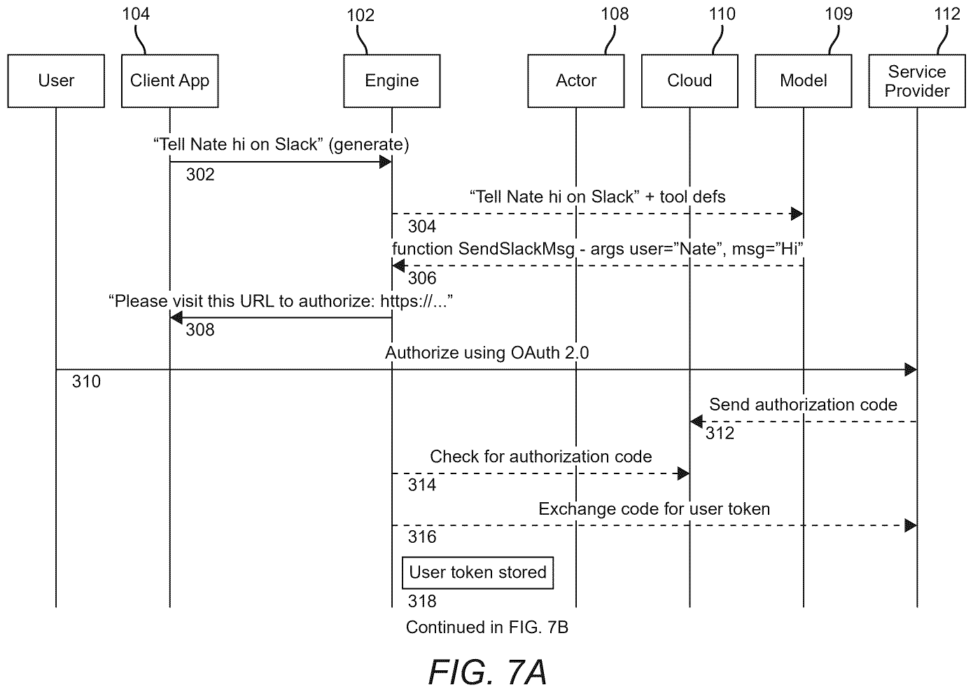

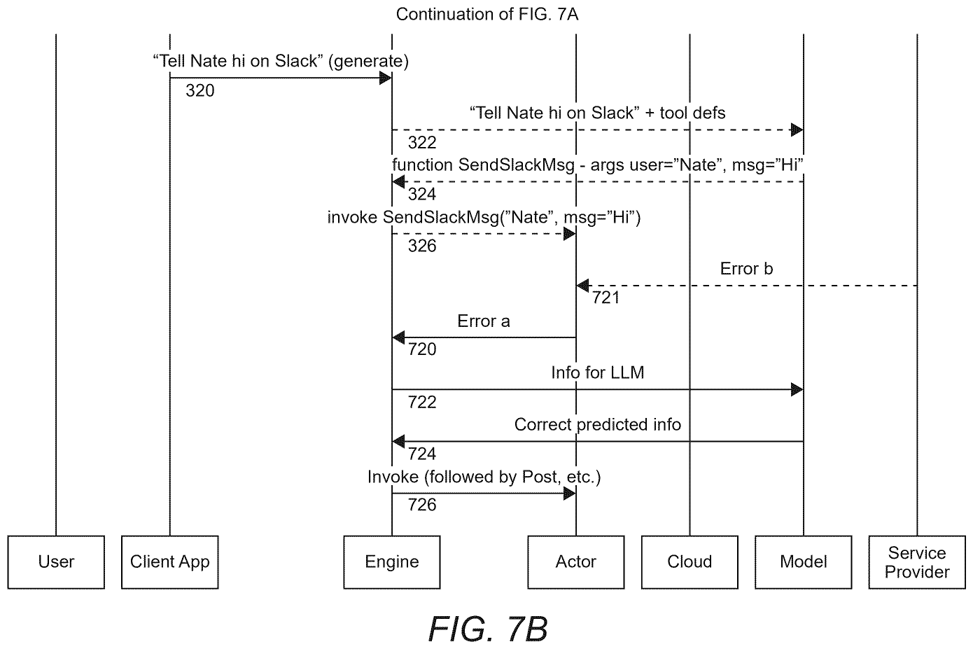

With reference to FIGS. 7A-B, embodiments of the disclosure provide error handling for errors in the request itself (“Error a,” e.g., validation errors) and errors arising from execution (“Error b”).

The engine 102 may receive information from the actor 108 that can be provided to the LLM 109 to retry the request with a greater chance of success, e.g. predict tool arguments with greater accuracy given additional information.

FIGS. 7A-B depict a sequence diagram for error handling. The error handling process occurs after an error arises from the engine 102 invoking execution of a tool function by an actor 108 (step 326).

In response to a validation error (Error a), the actor 108 cannot execute the request. Alternatively, the service provider 112 may return to the actor 108 an error arising during execution (Error b, shown in dashed line) (721).

For either type of error, the actor 108 may return to the engine 102 an error message including a flag indicating failure, and an indication of the nature of the error (720).

For example, instead of requesting to send a Slack dm to “Nate” (as shown in the figure), the user may instead mistype the name as “Natee.” This error would not be detected by the actor 108. Instead, in this example, the service provider 112 does not find “Natee” in the Slack user list. The service provider 112 may return an error message (Error b) indicating execution failure along with the nature of the error to the engine 102 via the actor 108 (721 and 720).

In response to the nature of the error, the engine 102 resends to the LLM 109 the previous model request (similar to step 322) with appended information from actor 108 to enable the LLM 109 to predict information to ensure a greater chance of successful execution (722). In this example, the engine 102 may append the model request to the LLM 109 with the entire Slack user list accessible to the requesting user. (See FIGS. 5A-5C “if not user_id.”) With that information, the LLM 109 can predict which listed user (e.g., “Nate”) matches the user “Natee” identified in the request.

The LLM 109 responds to the engine 102 with the correct predicted name (“Nate”) (724).

The engine 102 again invokes execution of the tool function by the actor 108 with the correct predicted information (“Nate”) (726), which should result in execution without the error.

(For both types of error handling, the steps following the invoke function (726) are not shown, but may be similar to those following 326 above.)

### Improvements in Technology

In addition to advantages discussed above (see, e.g., FIG. 4B discussion), embodiments of the disclosure provide the following improvements over conventional LLM strategies.

Tool execution is architecturally separated from client app, so tool execution scales separately—can use different hardware (e.g., GPU), can use different compute paradigms (e.g., server-less), not locked into a specific LLM framework (e.g., Langchain), so it works with any framework. Software dependencies can be different, enabling new use cases, and rapid development and versioning separate from the client app.

Management of tools (and their definitions) is also much easier for the developer. Developers can now have hundreds of different groups of tools they can call on that each serve different purposes (or features), e.g., one for social media tools, one for sales people, etc. Handling large numbers of tools is difficult or impossible with conventional LLM strategies, because LLM tool selection performance degrades nearly linearly with each tool added to the LLM request after a threshold (e.g., 20 tools). According to embodiments of the disclosure, even if models grow to effectively select from hundreds of tool definitions, grouping will still make the prediction more accurate, easier to develop and evaluate, and in most cases more computationally efficient.

Previously, developers needed entire frameworks (Langchain, llama index, crewAI, etc) to just execute tools which constrained them to certain languages (py, ts), certain design patterns and abstractions, and certain tools (a developer cannot just put a computationally expensive tool in a client app). According to embodiments of the disclosure, tool calling is available to any developer in any language that can make an HTTP request. Given concurrent primitives in most languages, this means the client app is nearly unaffected by making a complex tool call. The same is not true of most conventional utilizations of frameworks in client apps today where the tools must be executed by the developer in the client application or otherwise dealt with.

### Computer System

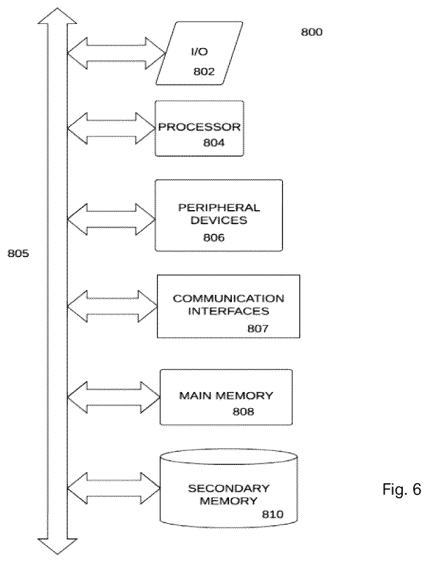

FIG. 6 illustrates an example of a computer system 800 that may be used to execute program code stored in a non-transitory computer readable medium (e.g., memory). The computer system includes an input/output subsystem 802, which may be used to interface with human users or other computer systems depending upon the application. The I/O subsystem 802 may include, e.g., a keyboard, mouse, graphical user interface, touchscreen, or other interfaces for input, and, e.g., an LED or other flat screen display, or other interfaces for output, including application program interfaces (APIs). Elements of embodiments of the disclosure may be implemented using a processor and memory like those in computer system 800.

Program code may be stored in non-transitory media such as persistent storage in secondary memory 810 or main memory 808 or both. Main memory 808 may include volatile memory such as random access memory (RAM) or non-volatile memory such as read only memory (ROM), as well as different levels of cache memory for faster access to instructions and data. Secondary memory may include persistent storage such as solid state drives, hard disk drives or optical disks. One or more processors 804 reads program code from one or more non-transitory media and executes the code to enable the computer system to accomplish the methods performed by the embodiments herein. Those skilled in the art will understand that the processor(s) may ingest source code, and interpret or compile the source code into machine code that is understandable at the hardware gate level of the processor(s) 804. The processor(s) 804 may include graphics processing units (GPUs) for handling computationally intensive tasks.

The processor(s) 804 may communicate with external networks via one or more communications interfaces 807, such as a network interface card, WiFi transceiver, etc. A bus 805 communicatively couples the I/O subsystem 802, the processor(s) 804, peripheral devices 806, communications interfaces 807, memory 808, and persistent storage 810. Embodiments of the disclosure are not limited to this representative architecture. Alternative embodiments may employ different arrangements and types of components, e.g., separate buses for input-output components and memory subsystems.

Those skilled in the art will understand that some or all of the elements of embodiments of the disclosure, and their accompanying operations, may be implemented wholly or partially in hardware, software or firmware (e.g., programmable gate arrays), as would be recognized by a skilled artisan.

Although the disclosure may not expressly disclose that some embodiments or features described herein may be combined with other embodiments or features described herein, this disclosure should be read to describe any such combinations that would be practicable by one of ordinary skill in the art. Unless otherwise indicated herein, the term “include” shall mean “include, without limitation,” the term “or” shall mean non-exclusive “or” in the manner of “and/or,” and the phrase “based upon” or the like shall mean “based at least in part upon,” or the like.

All references cited herein, including, without limitation, articles, publications, patents, patent publications, and patent applications, are incorporated by reference in their entireties for all purposes, except that any portion of any such reference is not incorporated by reference herein to the extent it: (1) is inconsistent with embodiments of the disclosure expressly described herein; (2) limits the scope of any embodiments described herein; or (3) limits the scope of any terms of any claims recited herein. Mention of any reference, article, publication, patent, patent publication, or patent application cited herein is not, and should not be taken as an acknowledgment or any form of suggestion that it constitutes valid prior art or forms part of the common general knowledge in any country in the world, or that it discloses essential matter.

In the claims/embodiments below, a claim/embodiment n reciting “any one of the preceding claims/embodiments starting with claim/embodiment x,” shall refer to any one of the claims/embodiments starting with claim/embodiment x and ending with the immediately preceding claim/embodiment (claim/embodiment n−1). For example, claim 35 reciting “The system of any one of the preceding claims starting with claim 28” refers to the system of any one of claims 28-34.

### Embodiments

An embodiment (e.g., a dependent embodiment) that refers to another embodiment is understood to refer to the other embodiment within the same embodiment set, unless otherwise indicated.

### System Embodiment Set

1. A system for processing requests, the system comprising:
   a. an orchestration engine comprising:
      i. one or more memories storing instructions; and
      ii. one or more processors, operably coupled to the one or more memories, for executing the instructions to:
         1. receive a client request from a client application, wherein the client request is based upon a user request from a user, and the engine is separate from the client application;
         2. provide a model request, based upon the client request, to a first model of one or more models;
         3. receive, from the first model, a structured response based upon the model request; and
         4. cause tool-function execution of one or more tool functions based upon the structured response.
2. The system of embodiment 1, wherein the structured response includes one or more respective identifications of the one or more tool functions.
3. The system of any one of the preceding embodiments, wherein the structured response includes one or more respective arguments for the one or more tool functions.
4. The system of any one of the preceding embodiments, wherein the first model is a large language model.
5. The system of any one of the preceding embodiments starting with embodiment 3, wherein the one or more tool functions and the one or more arguments are predicted by the first model.
6. The system of any one of the preceding embodiments, wherein the model request comprises one or more tool definitions.
7. The system of embodiment 6, wherein at least one of the tool definitions is in a format specific to the first model.
8. The system of any one of the preceding embodiments starting with embodiment 3, wherein execution comprises:
   a. supplying the one or more arguments to one or more respective actors of one or more actors for executing the one or more tool functions using the one or more arguments.
9. The system of embodiment 8, wherein the system comprises the one or more actors.
10. The system of any one of the preceding embodiments, wherein the instructions, when executed, cause the engine to:
   a. provide a result of the tool-function execution to a second model of the one or more models, wherein the second model is the same as or different from the first model; and
   b. receive a second result, based on the result, from the second model.
11. The system of embodiment 10, wherein the instructions, when executed, cause the engine to:
   provide the second result to the client application.
12. The system of any one of the preceding embodiments starting with embodiment 10, wherein the second result comprises a natural language summary of the result.
13. The system of any one of the preceding embodiments, wherein
   a. for at least one tool function of the one or more tool functions:
      i. if authorization is required for execution of the tool function by a corresponding service provider of one or more service providers:
         1. provide, to the client application, information to enable access to the corresponding service provider; and
         2. receive an indication of access permission for access to the corresponding service provider,
         3. wherein the access permission indication enables execution of the tool function.
14. The system of embodiment 13, wherein the information to enable access comprises an authorization URL.
15. The system of any one of the preceding embodiments starting with embodiment 13, wherein the access permission indication is received during a current session, and enables execution of the tool function based on a subsequent client request associated with the user.
16. The system of any one of the preceding embodiments starting with embodiment 13, wherein the system further comprises a remote server in which the engine does not reside, wherein
   a. receiving the access permission indication comprises receiving the access permission indication from a corresponding authorization provider via the remote server.
17. The system of any one of the preceding embodiments starting with embodiment 13, wherein the instructions, when executed, cause the engine to:
   a. associate an access token with the access permission indication.
18. The system of any one of the preceding embodiments starting with embodiment 13, wherein the instructions, when executed, cause the engine to:
   a. receive a second client request associated with the user from the client application;
   b. receive a second structured response from a third model of the one or more models, wherein the third model is the same as or different from the first model, and the second structured response is based upon the second client request; and
   c. based upon the access permission indication, enable execution of the tool function based upon the second structured response.
19. The system of any one of the preceding embodiments, wherein the engine is operable to select the first model based upon performance of the first model.
20. The system of any one of the preceding embodiments, wherein the engine is operable to:
   a. determine a context based upon the client request; and
   b. provide the context to the first model, wherein the first model is operable to select the one or more tool functions based upon the context.
21. The system of any one of embodiments 1-9 or 13-20, wherein the engine is operable to provide a result of the tool-function execution to the client application.
22. The system of any one of the preceding embodiments starting with embodiment 18, wherein the third model is the same as or different from the second model.
23. The system of embodiment 8, wherein the one or more actors include an email actor, an enterprise collaboration actor, a math actor, a weather actor, or a cloud computing platform actor.

### Error Handling: Retriable Tool Calling

24. A system for handling errors in request processing, the system comprising:
   a. an orchestration engine comprising:
      i. one or more memories storing instructions; and
      ii. one or more processors, operably coupled to the one or more memories, for executing the instructions to:
         1. receive a client request from a client application, wherein the client request is based upon a user request from a user, and the engine is separate from the client application;
         2. provide a model request, based upon the client request, to a first model of one or more models;
         3. receive, from the first model, a structured response based upon the model request; and
         4. based upon the structured response, provide a modified model request to a second model of the one or more models, wherein the second model may be the same as or different from the first model
25. The system of embodiment 24, wherein the modified model request is provided in response to a validation error in the structured response.
26. The system of any one of the preceding embodiments starting with embodiment 24, further comprising instructions that, when executed, cause the system to:
   a. before providing the modified model request, cause execution of one or more tool functions based upon the structured response.
27. The system of embodiment 26, wherein the modified model request is provided in response to an error in the tool-function execution.
28. The system of any one of the preceding embodiments starting with embodiment 26, wherein an indication of the error is provided by a service provider executing at least one of the one or more tool functions.

### Tool Evaluation Framework

29. A tool evaluation system for evaluating tools for request processing, the system comprising:
   a. an orchestration engine comprising:
      i. one or more memories storing instructions; and
      ii. one or more processors, operably coupled to the one or more memories, for executing the instructions to:
         1. provide a test model request to a first model of one or more models;
         2. receive, from the first model, a structured response based upon the test model request, wherein structured response specifies one or more tool functions or one or more arguments predicted by the first model; and
         3. provide, based on the structured response, a corresponding score indicating performance of the first model's tool calling capability.
30. The system of embodiment 29, wherein the structured response comprises a first argument predicted by the first model, and the corresponding score is based upon comparing the first argument to an expected argument.
31. The system of any one of the embodiments starting with embodiment 29, wherein the structured response comprises a first tool function name predicted by the first model, and the corresponding score is based upon comparing the first tool function name to an expected tool function name.
32. The system of embodiment 31, wherein the instructions, when executed, cause:
   a. for each tool function and each argument, providing one or more evaluation classifications based upon a comparison of the corresponding score to one or more thresholds.
33. The system of embodiment 32, wherein the one or more thresholds are adjustable.
34. The system of any one of the preceding embodiments starting with embodiment 29, wherein a composite score for the structured response is based upon the respective corresponding scores for the one or more tool functions and the one or more arguments.
35. The system of any one of the preceding embodiments starting with embodiment 29, wherein the instructions, when executed, cause:
   a. determining the corresponding score based upon a comparison of tool function calls in the received structured response with combinations of expected tool function calls.
36. The system of any one of the preceding embodiments starting with embodiment 29, wherein a statistical score is based upon corresponding scores for structured responses following two or more executions of providing test model requests, receiving structured responses, and providing corresponding scores.
37. Reserved

### Universal Format

38. The system of any one of the preceding embodiments, wherein the model request comprises second tool information in a format compatible with the first model, the second tool information is a translation of first tool information, and the second tool information is provided by the engine based on the first tool information.
39. The system of embodiment 38, wherein the first tool information is provided by a developer using an SDK associated with the engine.
40. The system of any one of the preceding embodiments starting with embodiment 38, wherein the instructions, when executed, cause the engine to:
   determine the second tool information by translating the first tool information.

### Authorization

41. A system for authorizing requests, the system comprising:
   a. an orchestration engine comprising:
      i. one or more memories storing instructions; and
      ii. one or more processors, operably coupled to the one or more memories, for executing the instructions to:
         1. receive a client request from a client application, wherein the client request is based upon a user request from a user, and the engine is separate from the client application;
         2. provide a model request, based upon the client request, to a first model of one or more models;
         3. receive, from the first model, a structured response specifying one or more tool functions based upon the model request; and
         a. for at least one tool function of the one or more tool functions:
         i. if authorization is required for execution of the tool function by a corresponding service provider of one or more service providers:
         1. provide, to the client application, information to enable access to the corresponding service provider; and
         2. receive an indication of access permission for access to the corresponding service provider,
         3. wherein the access permission indication enables execution of the tool function.
42. The system of embodiment 41 wherein the information to enable access comprises an authorization URL.
43. The system of any one of the preceding embodiments starting with embodiment 41, wherein the instructions, when executed, cause the engine to:
   a. receive a second client request from the client application;
   b. receive a second structured response from a third model of the one or more models, wherein the third model is the same as or different from the first model, and the second structured response is based upon the second client request;
   c. based upon the access permission indication, enable execution of the tool function based upon the second structured response.
44. The system of any one of the preceding embodiments starting with embodiment 41, wherein the system further comprises a remote server in which the engine does not reside, wherein receiving the access permission indication comprises receiving the access permission indication from a corresponding authorization provider via the remote server.
45. The system of any one of the preceding embodiments starting with embodiment 41, wherein wherein the access permission indication is received during a current session, and enables execution of the tool function based on a subsequent client request associated with the user.
46. The system of any one of the preceding embodiments starting with embodiment 41, wherein the instructions, when executed, cause the engine to associate an access token with the access permission indication.
47. The system of any one of the preceding embodiments starting with embodiment 41, wherein the instructions, when executed, cause the system to cause execution of the tool function based upon the structure response and access permission indication.
48. The system of embodiment 47, wherein the instructions, when executed, cause the engine to:
   a. provide a result of the execution to a second model of the one or more models, wherein the second model is the same as or different from the first model; and
   b. receive a second result, based on the result, from the second model.
49. The system of embodiment 48, wherein the instructions, when executed, cause the engine to
   provide the second result to the client application.
50. The system of any one of the preceding embodiments starting with embodiment 48, wherein the second result comprises a natural language summary of the result.

### Method Embodiment Set

51. A method comprising the operations performed by any one of the preceding system embodiments.

### CRM Embodiment Set

52. One of more non-transitory computer readable media comprising instructions that, when executed, cause performance of the operations performed by any one of the preceding system embodiments.

1. A system for processing requests, the system comprising:
a. one or more memories storing instructions; and
b. one or more processors, operably coupled to the one or more memories, for executing the instructions that cause the system to:
i. provide a model request, based upon a client request, to a first model of one or more models, wherein the client request is based upon a user request from a user;
ii. receive, from the first model, a structured response based upon the model request; and
iii. cause tool-function execution of one or more tool functions based upon the structured response.

2. The system of claim 1, wherein the structured response includes one or more respective identifications of the one or more tool functions.

3. The system of claim 1, wherein the structured response includes one or more respective arguments for the one or more tool functions.

4. The system of claim 1, wherein the first model is a large language model.

5. The system of claim 3, wherein the one or more tool functions and the one or more arguments are predicted by the first model.

6. The system of claim 1, wherein the model request comprises one or more tool definitions.

7. The system of claim 6, wherein at least one of the tool definitions is in a format specific to the first model.

8. The system of claim 3, wherein execution comprises:
a. supplying the one or more arguments to one or more respective actors of one or more actors for executing the one or more tool functions using the one or more arguments.

9. The system of claim 8, wherein the system comprises the one or more actors.

10. The system of claim 1, wherein the instructions, when executed, cause the system to:
a. provide a result of the tool-function execution to a second model of the one or more models, wherein the second model is the same as or different from the first model; and
b. receive a second result, based on the result, from the second model.

11. The system of claim 10, wherein the instructions, when executed, cause the system to:
a. provide the second result to a client application.

12. The system of claim 10, wherein the second result comprises a natural language summary of the result.

13. The system of claim 1, wherein
a. for at least one tool function of the one or more tool functions:
i. if authorization is required for execution of the tool function by a corresponding service provider of one or more service providers:
1. provide, to a client application, information to enable access to the corresponding service provider; and
2. receive an indication of access permission for access to the corresponding service provider,
3. wherein the access permission indication enables execution of the tool function.

14. The system of claim 13, wherein the information to enable access comprises an authorization URL.

15. The system of claim 13, wherein the access permission indication is received during a current session, and enables execution of the tool function based on a subsequent client request associated with the user.

16. The system of claim 13, wherein the system further comprises a remote server, wherein
a. receiving the access permission indication comprises receiving the access permission indication from a corresponding authorization provider via the remote server.

17. The system of claim 13, wherein the instructions, when executed, cause the system to:
a. associate an access token with the access permission indication.

18. The system of claim 13, wherein the instructions, when executed, cause the system to:
a. receive a second client request associated with the user from the client application;
b. receive a second structured response from a third model of the one or more models, wherein the third model is the same as or different from the first model, and the second structured response is based upon the second client request; and
c. based upon the access permission indication, enable execution of the tool function based upon the second structured response.

19. The system of claim 1, wherein the system is operable to select the first model based upon performance of the first model.

20. The system of claim 1, wherein the system is operable to:
a. determine a context based upon the client request; and
b. provide the context to the first model, wherein the first model is operable to select the one or more tool functions based upon the context.

21. The system of claim 1, wherein the system is operable to provide a result of the tool-function execution to a client application.

22. The system of claim 18, wherein the third model is the same as or different from the second model.

23. The system of claim 8, wherein the one or more actors include an email actor, an enterprise collaboration actor, a math actor, a weather actor, or a cloud computing platform actor.

24-37. (canceled)

38. The system of claim 1, wherein the model request comprises second tool information in a format compatible with the first model, the second tool information is a translation of first tool information, and the second tool information is provided by the system based on the first tool information.

39. The system of claim 38, wherein the first tool information is provided by a developer using an SDK.

40. The system of claim 38, wherein the instructions, when executed, cause the system to:
determine the second tool information by translating the first tool information.

41-50. (canceled)

51. The system of claim 1, wherein the instructions, when executed, further cause the system to:
a. receive the client request from a client application.

52. The system of claim 51, wherein the system comprises an orchestration engine comprising the one or more memories and the one or more processors, wherein the orchestration engine is separate from the client application.

53-57. (canceled)

58. A method comprising:
a. providing a model request, based upon a client request, to a first model of one or more models, wherein the client request is based upon a user request from a user;
b. receiving, from the first model, a structured response based upon the model request; and
c. causing tool-function execution of one or more tool functions based upon the structured response.

59. One of more non-transitory computer readable media comprising instructions that, when executed, cause performance of:
a. providing a model request, based upon a client request, to a first model of one or more models, wherein the client request is based upon a user request from a user;
b. receiving, from the first model, a structured response based upon the model request; and
c. causing tool-function execution of one or more tool functions based upon the structured response.
